(19) United States
(12) Patent Application Publication
(10) Pub. No.: US 2022/0394645 A1
(43) Pub. Date: Dec. 8, 2022

(54) SYNCHRONIZATION OF FRAMES IN MULTIPLE STREAMS IN A WIRELESS COMMUNICATIONS SYSTEM (WCS)

(71) Applicant: Corning Research & Development Corporation, Corning, NY (US)

(72) Inventors: Shlomi Kulik, Elkana (IL); Yishay Miller, Elad (IL)

(21) Appl. No.: 17/337,158

(22) Filed: Jun. 2, 2021

(51) Int. Cl. H04W 56/00; H04W 72/04; H04W 88/08

(52) U.S. Cl. CPC H04W 56/008; H04W 72/0446; H04W 88/085

(57) ABSTRACT

In an exemplary aspect, a digital routing unit (DRU) may have two signal streams that require synchronization therebetween. To provide such synchronization, the DRU may insert a frame counter into signals being sent to remote units. If both signals are sent to the same remote unit, the remote unit may synchronize by matching frames having the same frame counter. The remote unit may also determine a time of arrival difference between frames having the same frame counter and buffer frames accordingly to assist in synchronizing the frames. If the two signals are sent to different remote units, the remote units may send the counter back to the DRU, which can calculate a round trip time difference and insert a phase offset in future transmissions to assist in synchronization. In this fashion, the frames may be synchronized to assist in meeting the relevant fourth generation (4G) or fifth generation (5G) requirements.

### BACKGROUND

The disclosure relates generally to synchronization of frames in a common public radio interface (CPRI) communication link in a wireless communications device, such as a long term evolution (LTE) fourth generation (4G), fifth generation (5G), or a 5G-new radio (5G-NR) base station (eNB), in a wireless communications system (WCS), such as a 5G or a 5G-NR system and/or a distributed communications system (DCS).

Wireless communication is rapidly growing, with ever-increasing demands for high-speed mobile data communication. As an example, local area wireless services (e.g., so-called “wireless fidelity” or “WiFi” systems) and wide area wireless services are being deployed in many different types of areas (e.g., coffee shops, airports, libraries, etc.). Communications systems have been provided to transmit and/or distribute communications signals to wireless devices called “clients,” “client devices,” or “wireless client devices,” which must reside within the wireless range or “cell coverage area” to communicate with an access point device. Example applications where communications systems can be used to provide or enhance coverage for wireless services include public safety, cellular telephony, wireless local access networks (LANs), location tracking, and medical telemetry inside buildings and over campuses. One approach to deploying a communications system involves the use of radio nodes/base stations that transmit communications signals distributed over physical communications medium to remote units forming radio frequency (RF) antenna coverage areas, also referred to as “antenna coverage areas.” The remote units each contain, or are configured to couple to, one or more antennas configured to support the desired frequency(ies) of the radio nodes to provide the antenna coverage areas. Antenna coverage areas can have a radius in a range from a few meters up to twenty meters, as an example. Another example of a communications system includes radio nodes, such as base stations, that form cell radio access networks, wherein the radio nodes are configured to transmit communications signals wirelessly directly to client devices without being distributed through intermediate remote units.

In both 4G and 5G networks, it is not uncommon for signals to be transmitted and received using common public radio interface (CPRI). CPRI is a transport standard that defines a protocol for providing connectivity, synchronization and control communications between baseband units and remote radio units. Both 4G and 5G networks have stringent synchronization requirements. Accordingly, making sure that CPRI meets the synchronization requirements is a challenge which may benefit from new solutions.

No admission is made that any reference cited herein constitutes prior art. Applicant expressly reserves the right to challenge the accuracy and pertinency of any cited documents.

### SUMMARY

Aspects disclosed herein include systems and methods for synchronization of frames in multiple streams in a wireless communications system (WCS). In an exemplary aspect, a digital routing unit (DRU) may have two signal streams that require synchronization therebetween. To provide such synchronization, the DRU may insert a frame counter into signals being sent to remote units. If both signals are sent to the same remote unit, the remote unit may synchronize by matching frames having the same frame counter. The remote unit may also determine a time of arrival difference between frames having the same frame counter and buffer frames accordingly to assist in synchronizing the frames. If the two signals are sent to different remote units, the remote units may send the counter back to the DRU, which can calculate a round trip time difference and insert a phase offset in future transmissions to assist in synchronization. In this fashion, the frames may be synchronized to assist in meeting the relevant fourth generation (4G) or fifth generation (5G) requirements.

In this regard, in one exemplary embodiment, a remote unit is disclosed. The remote unit comprises an input configured to receive a first frame in a first stream, the first frame having a first frame counter number. The input is further configured to receive a second frame in a second stream, the second frame having a second frame counter number equal to the first frame counter number. The remote unit also comprises a buffer. The remote unit also comprises a control circuit configured to buffer the first frame in the buffer until the second frame arrives.

In another embodiment, a central unit device is disclosed. The central unit device comprises a counter configured to place a frame counter number in a frame. The central unit device also comprises a transmitter. The transmitter is configured to send a first frame with a first frame counter number to a first remote unit. The transmitter is also configured to send a second frame with the first frame counter number to a second remote unit. The central unit device also comprises a receiver. The receiver is configured to receive a third frame with the first frame counter number and a first timestamp from the first remote unit. The receiver is also configured to receive a fourth frame with the first frame counter number a second timestamp from the second remote unit. The central unit device also comprises a control circuit comprising a comparator. The control circuit is configured to compare with the comparator the first and second timestamps in the third and fourth frames and calculate a delay for a stream of frames corresponding to the first frame.

In another embodiment, a remote unit is disclosed. The remote unit comprises an input configured to receive a first frame in a first stream, the first frame having a first frame counter number. The remote unit also comprises a stamp and loopback circuit. The stamp and loopback circuit is configured to generate a timestamp on arrival of the first frame. The stamp and loopback circuit is also configured to insert the timestamp in a second frame. The stamp and loopback circuit is also configured to cause the second frame to be sent back to an origin of the first frame.

In another embodiment, a WCS is disclosed. The WCS comprises a DRU coupled to a centralized services node via a baseband unit (BBU). The DRU comprises a frame counter. The WCS also comprises a plurality of remote units each coupled to the DRU via a plurality of optical fiber-based communications media, respectively. The DRU is configured to receive a downlink communications signal from the centralized services node. The DRU is also configured to convert the downlink communications signal into a plurality of downlink communications signals. The DRU is also configured to distribute the plurality of downlink communications signals to the plurality of remote units using frames having frame counter numbers from the frame counter. The DRU is also configured to receive a plurality of uplink communications signals from the plurality of remote units, respectively. The DRU is also configured to convert the plurality of uplink communications signals into an uplink communications signal. The DRU is also configured to provide the uplink communications signal to the centralized services node.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary WCS having a digital routing unit (DRU) that communicates with one or more remote units and may require frame synchronization;

FIG. 2 is a schematic diagram of a common public radio interface (CPRI) transport link between a head end unit and a remote unit;

FIG. 3 is a diagram of a CPRI transmit stream compared to a CPRI receive stream illustrating the phase independence of the basic frame structure;

FIG. 4 is a schematic diagram of a conventional DRU-to-remote unit (RU) link having two CPRI connections therebetween;

FIG. 5 is a schematic diagram of frames arriving at the RU of FIG. 4 where one frame is buffered and delayed to align incorrectly;

FIG. 6 is a schematic diagram of a DRU-to-RU link having two CPRI connections therebetween using the frame counters according to an exemplary aspect of the present disclosure;

FIG. 7 is a schematic diagram of frames arriving at the RU of FIG. 6 with the frames buffered and delayed correctly;

FIG. 8 is a schematic diagram of a DRU-to-two-RU system having different CPRI connections therebetween;

FIG. 9A is a schematic diagram of the system of FIG. 8 with a loopback circuit to send frame counters back to the DRU;

FIG. 9B is a diagram of the relative phase of frames as they arrive pass through the loopback circuit in the RU of FIG. 9A;

FIG. 9C is a diagram of the frames arriving and leaving the RU of FIG. 9A;

FIG. 10 is a partial schematic cut-away diagram of an exemplary building infrastructure in a WCS, such as the WCS of FIG. 1;

FIG. 11 is a schematic diagram of an exemplary mobile telecommunications environment that can includes the WCS of FIG. 1; and

FIG. 12 is a schematic diagram of a representation of an exemplary computer system that can be included in or interfaced with any of the components in the WCS of FIG. 1, wherein the exemplary computer system is configured to execute instructions from an exemplary computer-readable medium.

### DETAILED DESCRIPTION

Embodiments disclosed herein include systems and methods for synchronization of frames in multiple streams in a wireless communications system (WCS). In an exemplary aspect, digital routing unit (DRU) may have two signal streams that require synchronization therebetween. To provide such synchronization, the DRU may insert a frame counter into signals being sent to remote units. If both signals are sent to the same remote unit, the remote unit may synchronize by matching frames having the same frame counter. The remote unit may also determine a time of arrival difference between frames having the same frame counter and buffer frames accordingly to assist in synchronizing the frames. If the two signals are sent to different remote units, the remote units may send the counter back to the DRU, which can calculate a round trip time difference and insert a phase offset in future transmissions to assist in synchronization. In this fashion, the frames may be synchronized to assist in meeting the relevant fourth generation (4G) or fifth generation (5G) requirements.

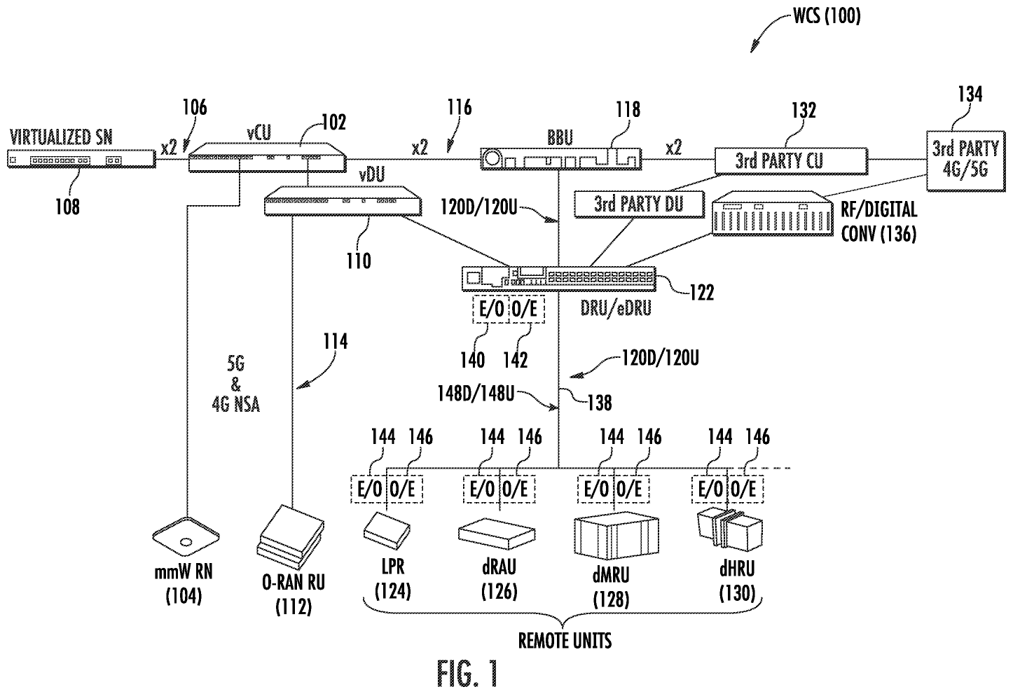

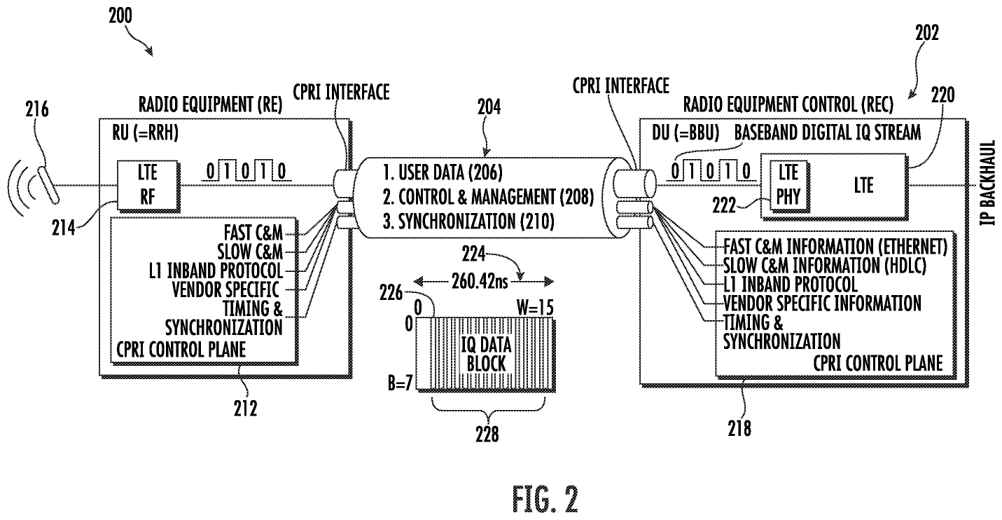

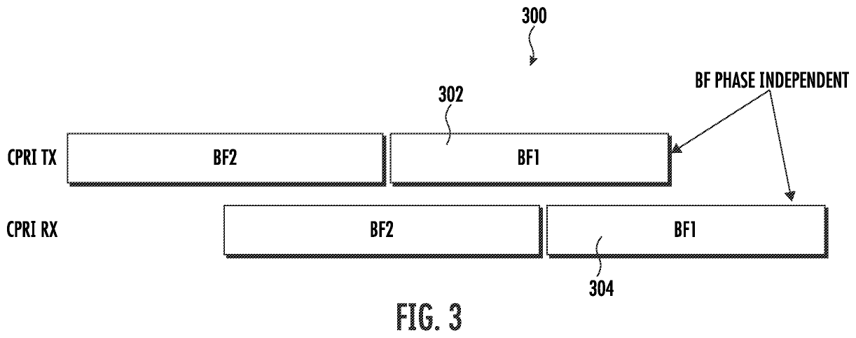

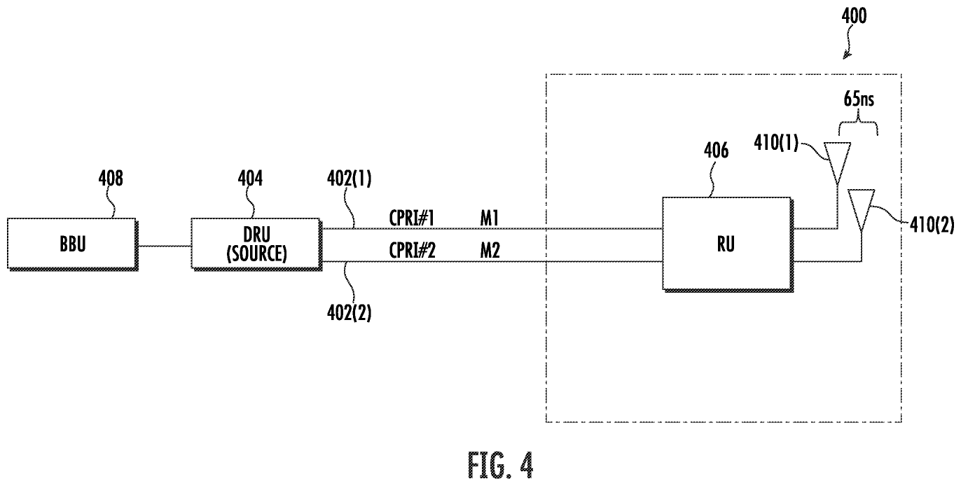

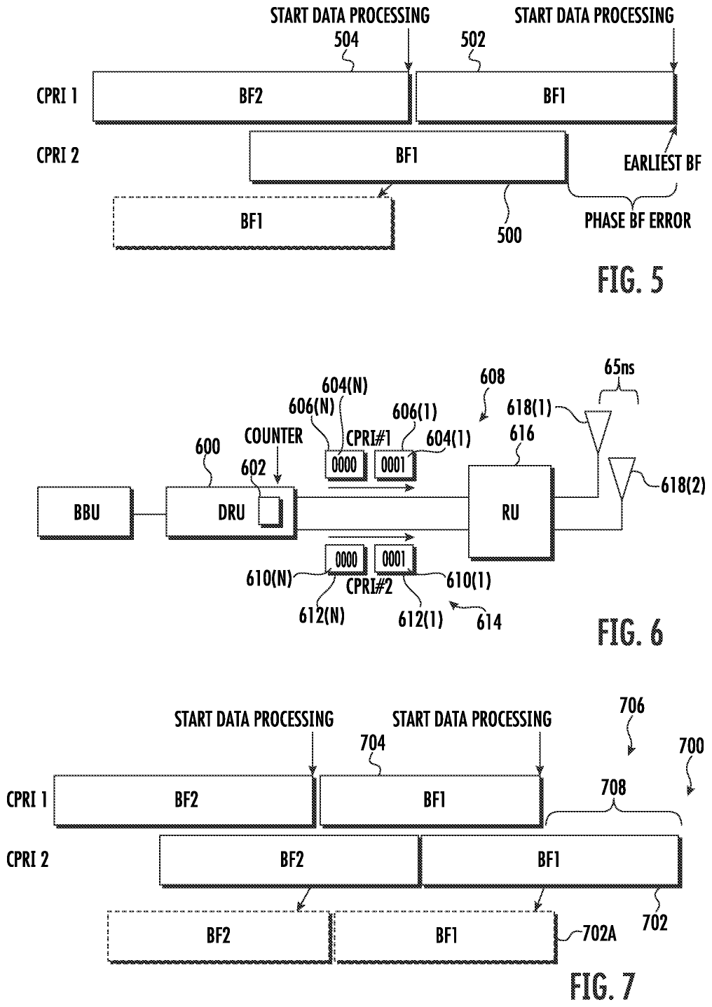

An overview of a WCS is provided with reference to FIG. 1 to give context to use of the frame counters in common public radio interface (CPRI) frames. A discussion of CPRI frame links is provided with reference to FIGS. 2 and 3 while FIGS. 4 and 5 illustrate short comings of existing systems having multiple CPRI links. A discussion of the frame counters and their use to synchronize CPRI frames according to exemplary aspects of the present disclosure is provided below beginning at FIG. 6.

In this regard, FIG. 1 is a schematic diagram of an exemplary WCS 100 configured according to any of the aspects disclosed herein to support synchronization of frames across multiple CPRI streams. The WCS 100 supports both legacy 4G long term evolution (LTE), 4G/5G non-standalone (NSA), and 5G standalone communications systems. As shown in FIG. 1, a centralized services node 102 is provided that is configured to interface with a core network to exchange communications data and distribute the communications data as radio signals to remote units. In this example, the centralized services node 102 is configured to support distributed communications services to an mmWave radio node 104. Despite that only one mmWave radio node 104 is shown in FIG. 1, it should be appreciated that the WCS 100 can be configured to include additional numbers of the mmWave radio node 104, as needed. The functions of the centralized services node 102 can be virtualized through an x2 interface 106 to another services node 108. The centralized services node 102 can also include one or more internal radio nodes that are configured to be interfaced with a distribution node 110 to distribute communications signals for the radio nodes to an open random access network (O-RAN) remote unit 112 that is configured to be communicatively coupled through an O-RAN interface 114.

The centralized services node 102 can also be interfaced through an x2 interface 116 to a digital baseband unit (BBU) 118 that can provide a digital signal source to the centralized services node 102. The digital BBU 118 is configured to provide a signal source to the centralized services node 102 to provide downlink communications signals 120D to the O-RAN remote unit 112 as well as to a digital routing unit (DRU) 122 as part of a digital distributed antenna system (DAS). The DRU 122 is configured to split and distribute the downlink communications signals 120D to different types of remote units, including a low-power remote unit (LPR) 124, a radio antenna unit (dRAU) 126, a mid-power remote unit (dMRU) 128, and a high-power remote unit (dHRU) 130. The DRU 122 is also configured to combine uplink communications signals 120U received from the LPR 124, the dRAU 126, the dMRU 128, and the dHRU 130 and provide the combined uplink communications signals 120U to the digital BBU 118. The digital BBU 118 is also configured to interface with a third-party central unit 132 and/or an analog source 134 through a radio frequency (RF)/digital converter 136.

The DRU 122 may be coupled to the LPR 124, the dRAU 126, the dMRU 128, and the dHRU 130 via an optical fiber-based communications medium 138. In this regard, the DRU 122 can include a respective electrical-to-optical (E/O) converter 140 and a respective optical-to-electrical (O/E) converter 142. Likewise, each of the LPR 124, the dRAU 126, the dMRU 128, and the dHRU 130 can include a respective E/O converter 144 and a respective O/E converter 146.

The E/O converter 140 at the DRU 122 is configured to convert the downlink communications signals 120D into downlink optical communications signals 148D for distribution to the LPR 124, the dRAU 126, the dMRU 128, and the dHRU 130 via the optical fiber-based communications medium 138. The O/E converter 146 at each of the LPR 124, the dRAU 126, the dMRU 128, and the dHRU 130 is configured to convert the downlink optical communications signals 148D back to the downlink communications signals 120D. The E/O converter 144 at each of the LPR 124, the dRAU 126, the dMRU 128, and the dHRU 130 is configured to convert the uplink communications signals 120U into uplink optical communications signals 148U. The O/E converter 142 at the DRU 122 is configured to convert the uplink optical communications signals 148U back to the uplink communications signals 120U.

FIG. 2 illustrates a CPRI stream or link between a radio equipment (RE) 200 and a radio equipment control (REC) device 202. In an exemplary aspect, the RE 200 is a remote unit (RU) such as a remote radio head (RRH), a remote antenna unit (RAU), or the like. Likewise, the REC device 202 may be a BBU 118, a DRU 122, or the like. The RE 200 and the REC 202 may be connected by a CPRI link 204, which may have a primary channel 206 for user data, a secondary channel 208 for control and management commands and data, and a third channel 210 for synchronization between end points (i.e., RE 200 and REC 202). These channels 206, 208, and 210 are multiplexed onto the CPRI link 204, which, in an exemplary aspect, may be a fiber optical cable or the like. The RE 200 may include a CPRI control plane 212 and an LTE RF transceiver 214 that operates with an antenna 216. Similarly, the REC 202 may have a CPRI control plane 218 and an LTE circuit 220 with an LTE physical layer (PHY) 222 therein. The CPRI channels 206, 208, 210 use a basic frame 224 that may be, for example, 128 bits, with an overhead section 226 (e.g., 8 bits) and a payload section 228 (e.g., 120 bits). The frame 224 may be, for example, 260.42 nanoseconds (ns) long under the CPRI standard.

It should be appreciated that the CPRI standard is a full duplex transport standard with basic frames originating at either endpoint, and these basic frames may be phase independent as illustrated by signal flow 300 in FIG. 3. In particular, a basic frame 302 of the transmit stream is phase independent of a basic frame 304 of the receive stream.

In and of itself, CPRI is well suited for many purposes. Things get complicated when CPRI is layered into a 4G or 5G network. This complication comes from the Third Generation Partnership Project (3GPP), which defines requirements for signal synchronization between antenna ports. When signals for different antenna ports are sent on the same CPRI line, they are automatically synchronized as they are sent inside the same basic frames. While it is possible to send all the signals on the same CPRI line, this arrangement may cause suboptimal utilization of CPRI resources. Conversely, having multiple CPRI lines may result in optimal utilization of CPRI resources, but suffer because the frames in the different CPRI lines are not synchronized. Such misalignment may result in a delay of 260 ns (e.g., approximately the length of a basic frame).

An example system 400 with two CPRI lines 402(1)-402(2) connecting a DRU 404 to a RU 406 is provided in FIG. 4. In the system 400, the CPRI lines 402(1)-402(2) provide respective MIMO signals M1, M2 from a BBU 408 to the RU 406. There may be a delay difference between the CPRI stream from fiber misalignment, digital phase error (caused by line rate auto negotiation, which is done separately for each line, wake-up time, etc.), or the like. 4G and 5G standards may require no more than a 65 ns difference between signals from different antennas 410(1)-410(2) of the RU 406. However, as noted, misalignment may cause delays of 260 ns. This delay is a result of the frame being buffered and delayed to align to the next data phase as better illustrated in FIG. 5, where a frame 500, which should align with a frame 502, is instead buffered and delayed to align with a frame 504 (which is the second frame of that stream).

Exemplary aspects of the present disclosure provide a mechanism to correct for misalignment between different CPRI streams on different CPRI lines. In an exemplary aspect, better illustrated in FIG. 6, a DRU 600 maintains a counter 602 and inserts frame counter numbers 604(1)-604(N) in frames 606(1)-606(N) of a first stream 608 and inserts frame counter numbers 610(1)-610(N) in frames 612(1)-612(N) of a second stream 614. It should be appreciated that frames that are supposed to be synchronized together (e.g., frames 606(1) and 612(1)) would have the same frame counter number (e.g., 0000 or 0001 depending on if the counter 602 started at 0 or 1). On arrival at a RU 616, the RU 616 may use the frame counter numbers 604(1)-604(N), 610(1)-610(N) to align the frames 606(1)-606(N), 612(1)-612(N) properly and maintain the desired <65 ns difference between antennas 618(1)-618(2).

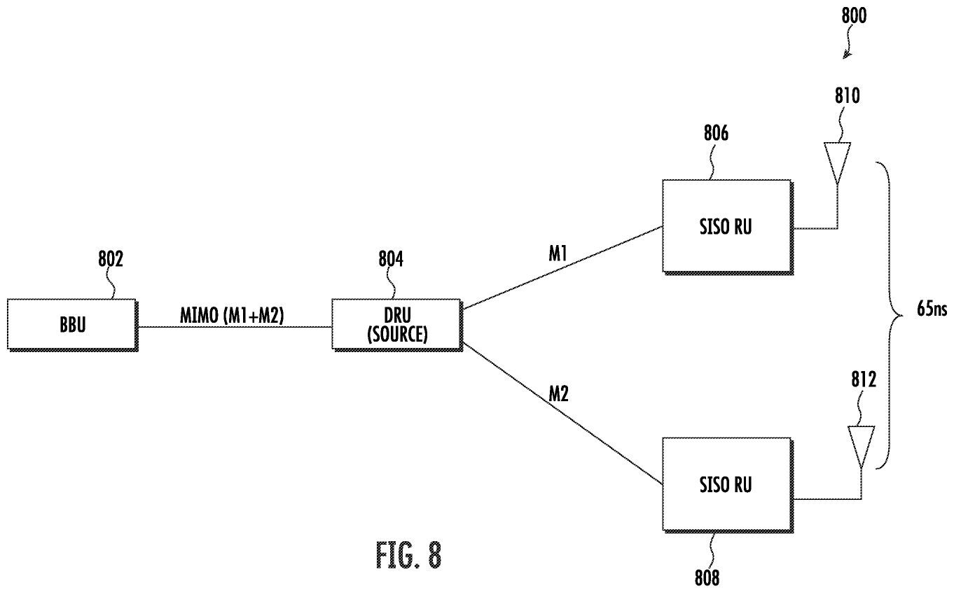

Thus, as better seen in FIG. 7, even though a stream 700 has a frame 702 arrive before a frame 704 of a stream 706, creating a phase error 708, the RU 616 buffers the frame 702 to create a buffered frame 702A, which is aligned with the arrival of the frame 704. There is no (or minimal) phase error between frames 702A and 704. The amount of buffering done by the RU 616 is based on when it detects the same frame counter numbers 604(1) and 610(1) in the respective frames 704, 702.

The RU 616 may do the comparison for the frame counters when the RU 616 receives both (or more than two) streams. However, there may be situations where streams to be synchronized are sent to different RUs as better illustrated in FIG. 8. Specifically, a WCS 800 may include a BBU 802 that sends two MIMO streams M1+M2 to a DRU 804. The DRU 804 splits the MIMO streams and sends M1 to a RU 806 using a first CPRI stream and sends M2 to a RU 808 using a second CPRI stream. The difference between signals originating at antennas 810 and 812 should be, according to 4G and 5G standards, less than 65 ns.

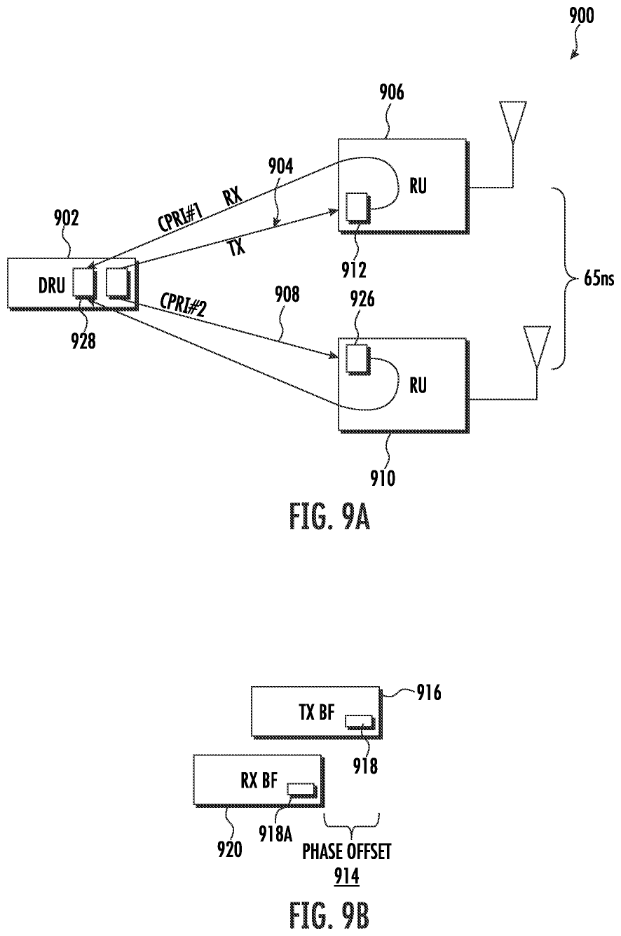

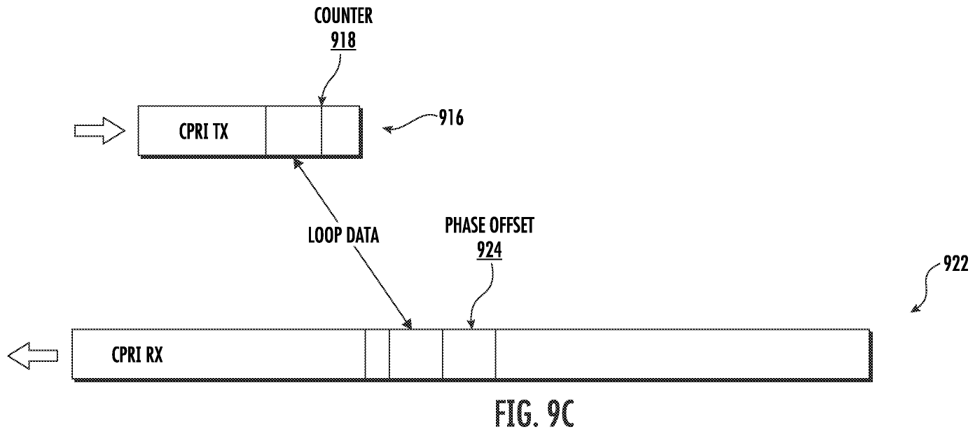

A solution to this situation is provided by including a stamp and loopback circuit within the RUs as better illustrated in FIGS. 9A-9C. In particular, a WCS 900 includes a DRU 902 that sends a first CPRI stream 904 to a first RU 906 and a second CPRI stream 908 to a second RU 910. The first RU 906 includes a stamp and loopback circuit 912 that checks the counter number within a frame and creates a time stamp of when the frame was received. The stamp and loopback circuit 912 may further know how long a loopback function takes internally within the RU 906. This length of time may be referred to as a phase offset 914 and is illustrated in FIG. 9B, where a frame 916 with a frame counter 918 is received, and a frame 920 with the frame counter 918A contained therein is being sent back to the DRU 902. While getting just the frame counter 918A back at the DRU 902 may help calculate a total round trip time, it does not account for the phase offset 914. Accordingly, as better seen in FIG. 9C, a return frame 922 may include not just the frame counter 918A, but also phase offset and time stamp information 924 from the stamp and loopback circuit 912. The RU 910 also has a stamp and loopback circuit 926.

The DRU 902 receives both return frames from the two RUs 906 and 910 and compares with a comparator 928 the time of receipt of the frames having the same frame counters. Based on the difference in time stamp and phase offsets, the DRU 902 may calculate a difference in time of receipt at the respective RU 906 and 910. The DRU 902 may then delay sending frames to one or the other RU 906 or 910 so that subsequent frames are properly synchronized for transmission by the RU 906 and 910.

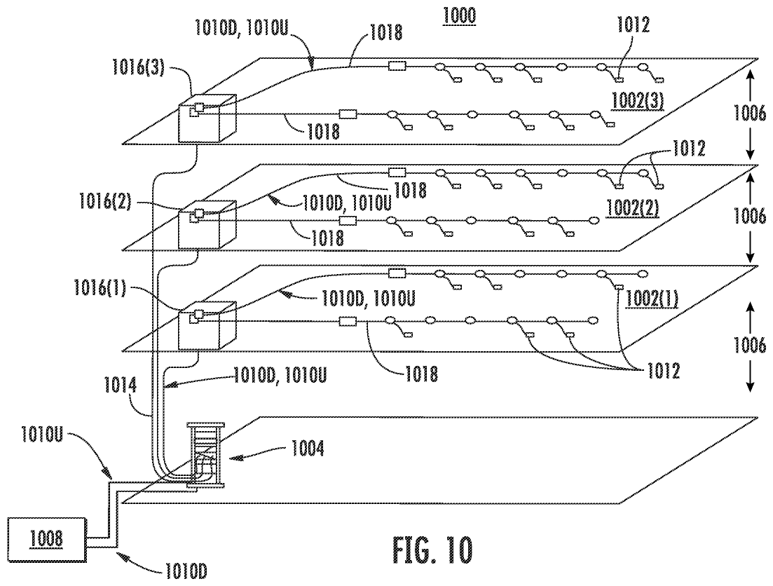

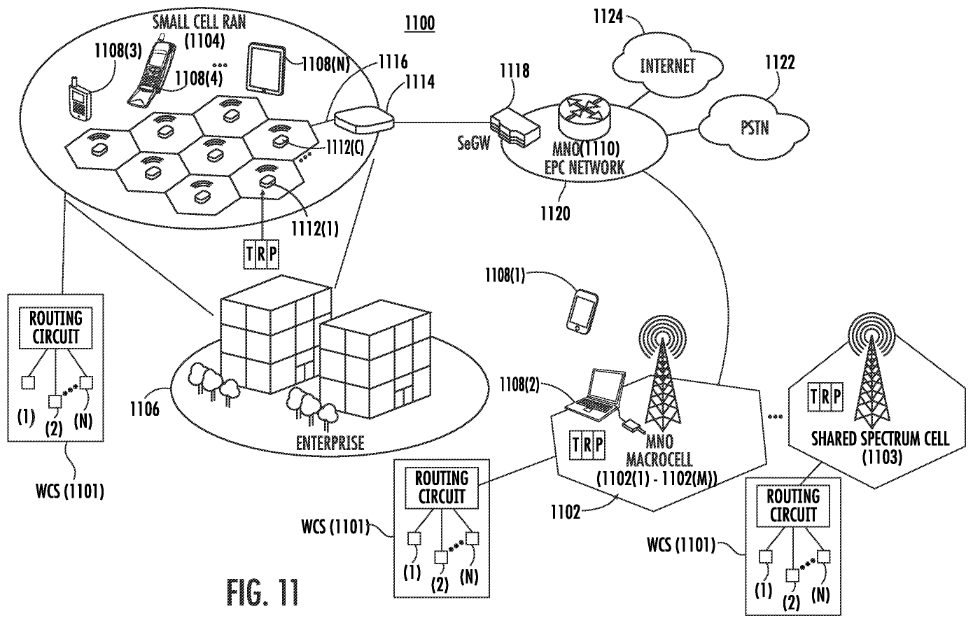

The WCS 100 of FIG. 1 can be provided in an indoor environment as illustrated in FIG. 10. FIG. 10 is a partial schematic cut-away diagram of an exemplary building infrastructure 1000 in a WCS, such as the WCS 100 of FIG. 1. The building infrastructure 1000 in this embodiment includes a first (ground) floor 1002(1), a second floor 1002(2), and a third floor 1002(3). The floors 1002(1)-1002(3) are serviced by a central unit 1004 to provide antenna coverage areas 1006 in the building infrastructure 1000. The central unit 1004 is communicatively coupled to a base station 1008 to receive downlink communications signals 1010D from the base station 1008. The central unit 1004 is communicatively coupled to a plurality of remote units 1012 to distribute the downlink communications signals 1010D to the remote units 1012 and to receive uplink communications signals 1010U from the remote units 1012, as previously discussed above. The downlink communications signals 1010D and the uplink communications signals 1010U communicated between the central unit 1004 and the remote units 1012 are carried over a riser cable 1014. The riser cable 1014 may be routed through interconnect units (ICUs) 1016(1)-1016(3) dedicated to each of the floors 1002(1)-1002(3) that route the downlink communications signals 1010D and the uplink communications signals 1010U to the remote units 1012 and also provide power to the remote units 1012 via array cables 1018.

The WCS 100 of FIG. 1 can also be interfaced with different types of radio nodes of service providers and/or supporting service providers, including macrocell systems, small cell systems, and remote radio heads (RRH) systems, as examples. For example, FIG. 11 is a schematic diagram of an exemplary mobile telecommunications environment 1100 (also referred to as “environment 1100”) that includes radio nodes and cells that may support shared spectrum, such as unlicensed spectrum, and can be interfaced to shared spectrum WCSs 1101 supporting coordination of distribution of shared spectrum from multiple service providers to remote units to be distributed to subscriber devices. The shared spectrum WCSs 1101 can include the WCS 100 of FIG. 1.

The environment 1100 includes exemplary macrocell RANs 1102(1)-1102(M) (“macrocells 1102(1)-1102(M)”) and an exemplary small cell RAN 1104 located within an enterprise environment 1106 and configured to service mobile communications between a user mobile communications device 1108(1)-1108(N) to a mobile network operator (MNO) 1110. A serving RAN for the user mobile communications devices 1108(1)-1108(N) is a RAN or cell in the RAN in which the user mobile communications devices 1108(1)-1108(N) have an established communications session with the exchange of mobile communications signals for mobile communications. Thus, a serving RAN may also be referred to herein as a serving cell. For example, the user mobile communications devices 1108(3)-1108(N) in FIG. 11 are being serviced by the small cell RAN 1104, whereas the user mobile communications devices 1108(1) and 1108(2) are being serviced by the macrocell 1102. The macrocell 1102 is an MNO macrocell in this example. However, a shared spectrum RAN 1103 (also referred to as “shared spectrum cell 1103”) includes a macrocell in this example and supports communications on frequencies that are not solely licensed to a particular MNO, such as CBRS for example, and thus may service user mobile communications devices 1108(1)-1108(N) independent of a particular MNO. For example, the shared spectrum cell 1103 may be operated by a third party that is not an MNO and wherein the shared spectrum cell 1103 supports CBRS. Also, as shown in FIG. 11, the MNO macrocell 1102, the shared spectrum cell 1103, and/or the small cell RAN 1104 can interface with a shared spectrum WCS 1101 supporting coordination of distribution of shared spectrum from multiple service providers to remote units to be distributed to subscriber devices. The MNO macrocell 1102, the shared spectrum cell 1103, and the small cell RAN 1104 may be neighboring radio access systems to each other, meaning that some or all can be in proximity to each other such that a user mobile communications device 1108(3)-1108(N) may be able to be in communications range of two or more of the MNO macrocell 1102, the shared spectrum cell 1103, and the small cell RAN 1104 depending on the location of the user mobile communications devices 1108(3)-1108(N).

In FIG. 11, the mobile telecommunications environment 1100 in this example is arranged as an LTE system as described by 3GPP as an evolution of the GSM/UMTS standards (Global System for Mobile communication/Universal Mobile Telecommunications System). It is emphasized, however, that the aspects described herein may also be applicable to other network types and protocols. The mobile telecommunications environment 1100 includes the enterprise environment 1106 in which the small cell RAN 1104 is implemented. The small cell RAN 1104 includes a plurality of small cell radio nodes 1112(1)-1112(C). Each small cell radio node 1112(1)-1112(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 11, the small cell RAN 1104 includes one or more services nodes (represented as a single services node 1114) that manage and control the small cell radio nodes 1112(1)-1112(C). In alternative implementations, the management and control functionality may be incorporated into a radio node, distributed among nodes, or implemented remotely (i.e., using infrastructure external to the small cell RAN 1104). The small cell radio nodes 1112(1)-1112(C) are coupled to the services node 1114 over a direct or local area network (LAN) connection 1116 as an example, typically using secure IPsec tunnels. The small cell radio nodes 1112(1)-1112(C) can include multi-operator radio nodes. The services node 1114 aggregates voice and data traffic from the small cell radio nodes 1112(1)-1112(C) and provides connectivity over an IPsec tunnel to a security gateway (SeGW) 1118 in a network 1120 (e.g., evolved packet core (EPC) network in a 4G network, or 5G Core in a 5G network) of the MNO 1110. The network 1120 is typically configured to communicate with a public switched telephone network (PSTN) 1122 to carry circuit-switched traffic, as well as for communicating with an external packet-switched network such as the Internet 1124.

The environment 1100 also generally includes a node (e.g., eNodeB or gNodeB) base station, or “macrocell” 1102. The radio coverage area of the macrocell 1102 is typically much larger than that of a small cell where the extent of coverage often depends on the base station configuration and surrounding geography. Thus, a given user mobile communications device 1108(3)-1108(N) may achieve connectivity to the network 1120 (e.g., EPC network in a 4G network, or 5G Core in a 5G network) through either a macrocell 1102 or small cell radio node 1112(1)-1112(C) in the small cell RAN 1104 in the environment 1100.

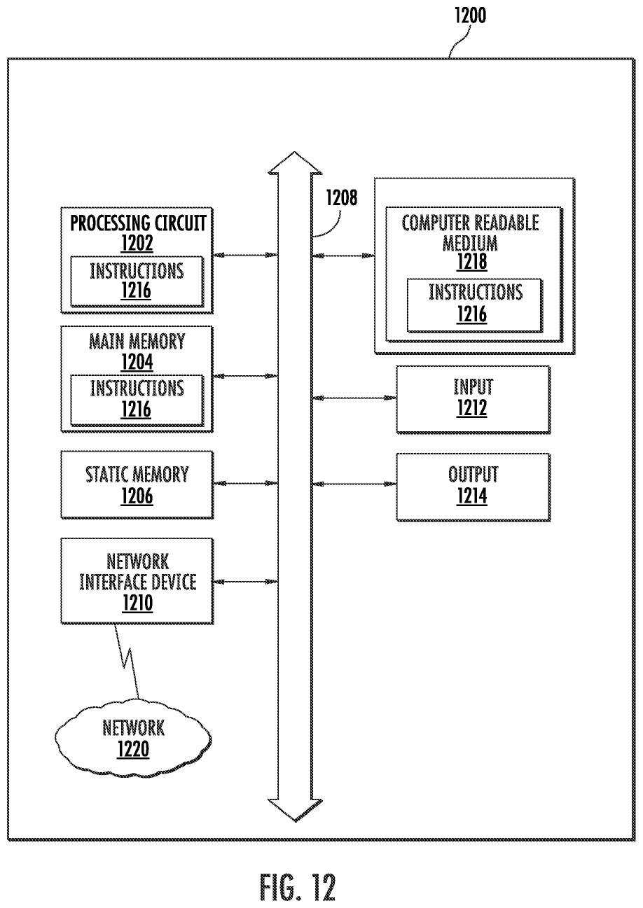

Any of the circuits in the WCS 100 of FIG. 1 such as the DRU, BBU, RU, or the like, can include a computer system 1200, such as that shown in FIG. 12, to carry out their functions and operations. With reference to FIG. 12, the computer system 1200 includes a set of instructions for causing the multi-operator radio node component(s) to provide its designed functionality, and the circuits discussed above. The multi-operator radio node component(s) may be connected (e.g., networked) to other machines in a LAN, an intranet, an extranet, or the Internet. The multi-operator radio node component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 1200 in this embodiment includes a processing circuit or processor 1202, a main memory 1204 (e.g., read-only memory (ROM), flash memory, dynamic random access memory (DRAM) such as synchronous DRAM (SDRAM), etc.), and a static memory 1206 (e.g., flash memory, static random access memory (SRAM), etc.), which may communicate with each other via a data bus 1208. Alternatively, the processing circuit 1202 may be connected to the main memory 1204 and/or static memory 1206 directly or via some other connectivity means. The processing circuit 1202 may be a controller, and the main memory 1204 or static memory 1206 may be any type of memory.

The processing circuit 1202 represents one or more general-purpose processing circuits such as a microprocessor, central processing unit, or the like. More particularly, the processing circuit 1202 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 1202 is configured to execute processing logic in instructions 1216 for performing the operations and steps discussed herein.

The computer system 1200 may further include a network interface device 1210. The computer system 1200 also may or may not include an input 1212 to receive input and selections to be communicated to the computer system 1200 when executing instructions. The computer system 1200 also may or may not include an output 1214, including, but not limited to, a display, a video display unit (e.g., a liquid crystal display (LCD) or a cathode ray tube (CRT)), an alphanumeric input device (e.g., a keyboard), and/or a cursor control device (e.g., a mouse).

The computer system 1200 may or may not include a data storage device that includes instructions 1216 stored in a computer-readable medium 1218. The instructions 1216 may also reside, completely or at least partially, within the main memory 1204 and/or within the processing circuit 1202 during execution thereof by the computer system 1200, the main memory 1204 and the processing circuit 1202 also constituting the computer-readable medium 1218. The instructions 1216 may further be transmitted or received over a network 1220 via a network interface device 1210.

While the computer-readable medium 1218 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the processing circuit and that cause the processing circuit to perform any one or more of the methodologies of the embodiments disclosed herein. The term “computer-readable medium” shall accordingly be taken to include, but not be limited to, solid-state memories, optical and magnetic medium, and carrier wave signals.

Note that as an example, any “ports,” “combiners,” “splitters,” and other “circuits” mentioned in this description may be implemented using Field Programmable Logic Array(s) (FPGA(s)) and/or a digital signal processor(s) (DSP(s)), and therefore, may be embedded within the FPGA or be performed by computational processes.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.).

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

We claim:

1. A remote unit comprising:
an input configured to receive a first frame in a first stream, the first frame having a first frame counter number;
the input further configured to receive a second frame in a second stream, the second frame having a second frame counter number equal to the first frame counter number;
a buffer; and
a control circuit configured to buffer the first frame in the buffer until the second frame arrives.

2. The remote unit of claim 1, wherein the input is coupled to a common public radio interface (CPRI) control plane and the first frame comprises a CPRI frame.

3. The remote unit of claim 1, further comprising an antenna array, wherein the control circuit is configured to transmit signals in the first frame and the second frame synchronously through the antenna array.

4. The remote unit of claim 3, wherein the antenna array is configured to transmit according to a fifth generation-new radio (5G-NR) protocol.

5. The remote unit of claim 1, wherein the input comprises a first connection to a first link and a second connection to a second link.

6. A central unit device, comprising:
a counter configured to place a frame counter number in a frame;
a transmitter configured to send:
a first frame with a first frame counter number to a first remote unit; and
a second frame with the first frame counter number to a second remote unit;
a receiver configured to receive:
a third frame with the first frame counter number and a first timestamp from the first remote unit; and
a fourth frame with the first frame counter number a second timestamp from the second remote unit; and
a control circuit comprising a comparator; the control circuit configured to compare with the comparator the first and second timestamps in the third and fourth frames and calculate a delay for a stream of frames corresponding to the first frame.

7. The central unit device of claim 6, wherein the first frame is associated with a common radio public interface (CPRI) stream of frames.

8. The central unit device of claim 6, further comprising a counter configured to generate frame counter numbers for use in frames.

9. The central unit device of claim 6, further comprising an optical output coupled to the transmitter and configured to connect to an optical medium for transmission of the first frame.

10. A remote unit comprising:
an input configured to receive a first frame in a first stream, the first frame having a first frame counter number; and
a stamp and loopback circuit configured to:
generate a timestamp on arrival of the first frame;
insert the timestamp in a second frame; and
cause the second frame to be sent back to an origin of the first frame.

11. The remote unit of claim 10, wherein the stamp and loopback circuit is further configured to determine a phase offset and insert the phase offset into the second frame.

12. The remote unit of claim 10, wherein the input comprises a fiber optic input.

13. The remote unit of claim 10, wherein the first frame further comprises data to be transmitted.

14. The remote unit of claim 13, further comprising an antenna array through which the data to be transmitted is transmitted.

15. The remote unit of claim 14, wherein the antenna array is configured to transmit using a fifth generation-new radio (5G-NR) protocol.

16. A wireless communications system (WCS), comprising:
a digital routing unit (DRU) coupled to a centralized services node via a baseband unit (BBU), the DRU comprising a frame counter; and
a plurality of remote units each coupled to the DRU via a plurality of optical fiber-based communications media, respectively;
wherein:
the DRU is configured to:
receive a downlink communications signal from the centralized services node;
convert the downlink communications signal into a plurality of downlink communications signals;
distribute the plurality of downlink communications signals to the plurality of remote units using frames having frame counter numbers from the frame counter;
receive a plurality of uplink communications signals from the plurality of remote units, respectively;
convert the plurality of uplink communications signals into an uplink communications signal; and
provide the uplink communications signal to the centralized services node.

17. The WCS of claim 16, wherein:
the DRU comprises:
an electrical-to-optical (E/O) converter configured to convert the plurality of downlink communications signals into a plurality of downlink optical communications signals, respectively; and
an optical-to-electrical (O/E) converter configured to convert a plurality of uplink optical communications signals into the plurality of uplink communications signals, respectively; and
the plurality of remote units each comprise:
a respective O/E converter configured to convert a respective one of the plurality of downlink optical communications signals into a respective one of the plurality of downlink communications signals; and
a respective E/O converter configured to convert a respective one of the plurality of uplink communications signals into a respective one of the plurality of uplink optical communications signals.

18. The WCS of claim 16, wherein a remote unit comprises a buffer and a control circuit, the control circuit configured to compare frame numbers in two different frames to determine that the frame numbers are the same and buffer a first-to-arrive frame until the second frame arrives.

19. The WCS of claim 16, wherein a remote unit comprises a stamp and loopback circuit configured to insert a time of arrival timestamp into a frame and send the frame back to the DRU.
